(19) United States
(12) Patent Application Publication
(10) Pub. No.: US 2026/0085240 A1
(43) Pub. Date: Mar. 26, 2026

(54) NANOCELLULOSE CONTAINING ULTRASTABLE WATER-BASED FOAM, METHOD OF PREPARING THE SAME AND USES THEREOF

(71) Applicants: Institute of Chemistry, Henan Academy of Sciences, Zhengzhou (CN); Henan Academy of Sciences, Zhengzhou (CN)

(72) Inventors: Huifang XIE, Zhengzhou (CN); Long YU, Zhengzhou (CN); Xinyi DONG, Zhengzhou (CN); Jun FU, Zhengzhou (CN); Litao MA, Zhengzhou (CN); Yiwen YANG, Zhengzhou (CN)

(21) Appl. No.: 19/266,114

(22) Filed: Jul. 10, 2025

(30) Foreign Application Priority Data
Sep. 26, 2024 (CN) 202411347365.1

(51) Int. Cl. C09K 17/52; C08K 5/05; C08K 5/41; C08L 1/02; C08L 29/04

(52) U.S. Cl. CPC C09K 17/52; C08K 5/05; C08K 5/41; C08L 1/02; C08L 29/04; C08K 2201/014; C08L 2201/54; C08L 2203/14

(57) ABSTRACT

The present invention belongs to the field of chemical industry and discloses a nanocellulose containing ultrastable water-based foam, a method of preparing the same, and uses thereof. The foam comprises, by mass fraction, the following components: based on 100 parts of the total mass of a compound water-based foam, 0.1-2.0 parts of nanocellulose hydrogel, 0.5-5.0 parts of sodium dodecyl sulfate, 1.0-5.0 parts of tetradecanol, 0.1-3.0 parts of polyvinyl alcohol, and the balance water. The above components are stirred at a high speed to generate a foam, thereby obtaining the nanocellulose containing ultrastable water-based foam.

### CROSS-REFERENCE TO RELATED APPLICATIONS

The present application claims priority to Chinese Patent Application No. 202411347365.1, filed Sep. 26, 2024, the entire disclosure of which is incorporated herein by reference.

### TECHNICAL FIELD

The present invention belongs to the field of chemical industry, and specifically relates to a nanocellulose containing ultrastable water-based foam, a method of preparing the same, and uses thereof.

### BACKGROUND

Foam systems are widely used in many fields such as daily chemicals, fire protection, mineral flotation, petrochemicals, and petroleum extraction (such as foam flooding of oil reservoirs). However, foam is generally an unstable system as film drainage, coalescence and disproportionation of bubbles necessarily occur, thereby reducing the free energy of the entire system. For better foam stability, surfactants, polymers, proteins, or surface-active solid particles are usually added to a foam system. Despite the easy and rapid movement to a gas-liquid interface by adding a surfactant, a high viscosity of a foam film when proteins and polymers are added, or an elastic layer formed by the coalescence of surface-active solid particles, these additives cannot effectively prevent bubbles from attenuation. The space occupied by a liquid foam film will spontaneously decrease to reduce the overall surface free energy of the system while maintaining the stability thereof. From a long-term perspective, the collapse of foam is irreversible. The instability of foam systems has always been a key factor restricting their applications. The existing foam stabilizers mainly include polymers and solid-phase nanomaterials, but there are still problems such as poor material performance, high cost and limited sources.

In modern agricultural production, mulching technology is widely used to increase soil temperature, keep soil moisture, inhibit weed growth and improve the environment of crop growth. The traditional mulch materials mainly include plastic films such as polyethylene and polyvinyl chloride. While playing a role, these materials also bring about a series of environmental and ecological problems. Plastic mulch films are not easy to degrade, and long-term residue in the soil will cause soil structure damage and microplastic pollution, giving rise to a negative impact on crops and the ecological environment.

To solve this problem, degradable mulch films have received widespread attention. A liquid foam mulch film having a soil improvement function is prepared by emulsification, which can be used as a sprayable green alternative to a petroleum-based plastic mulch film and a soil remediator for degraded soil. At present, there is no report on the use of a water-based foam as a foam mulch film.

### SUMMARY OF INVENTION

To solve the drawbacks and shortcomings in the prior art, the primary objective of the present invention is to provide a nanocellulose containing ultrastable water-based foam mulch film, and a method of preparing the same. The water-based foam mulch film prepared in the present invention has a high foamability, excellent stability, and is prepared in a simple process and easily prepared on a mass scale.

The objective of the present invention can be achieved through the following technical solutions.

A nanocellulose containing ultrastable water-based foam, characterized in that, by mass fraction, it comprises the following components: based on 100 parts of the total mass of a compound water-based foam, 0.1-2.0 parts of nanocellulose hydrogel, 0.5-5.0 parts of sodium dodecyl sulfate (SDS), 1.0-5.0 parts of tetradecanol (TDA), 0.1-3.0 parts of polyvinyl alcohol (PVA), and the balance water; the above components are stirred at a high speed to generate a foam, i.e., to obtain the ultrastable water-based foam.

Preferably, the nanocellulose comprised in the nanocellulose hydrogel has a length of 500-1000 nm and a diameter of 3-5 nm.

Preferably, the polyvinyl alcohol has an alcoholysis degree of 88%-100%.

Preferably, the mass ratio of sodium dodecyl sulfate:tetradecanol:polyvinyl alcohol:nanocellulose hydrogel is (2.5-5.0):2.0:(0.5-2.0):(0.5-1.5).

A method of preparing the ultrastable water-based foam, comprising the following steps:
(1) mixing sodium dodecyl sulfate and tetradecanol in water, heating the mixture to disperse all the solutes uniformly, and cooling the mixture before high-speed stirring to afford an SDS/TDA foam system;
(2) adding polyvinyl alcohol to the above foam system, and stirring at a high speed after complete dissolution; and
(3) adding nanocellulose hydrogel to the foam system of step (2), mixing uniformly, and then stirring at a high speed to afford a nanocellulose containing ultrastable water-based foam.

Preferably, the high-speed stirring conditions in steps (1) to (3) are all mechanical stirring at a stirring speed of 1000-1500 rpm for 5-10 min.

Preferably, the heating condition in step (1) is heating at 60±10° C. for 20±10 min.

Use of the nanocellulose containing ultrastable water-based foam in a foam mulch film.

Preferably, the ultrastable water-based foam can be sprayed onto a soil or water surface through high-pressure spray to form a foam mulch film.

The nanocellulose containing ultrastable water-based foam is formed by a multilayer foam. The present invention disperses nanocellulose uniformly in a water-based foam system, which significantly improves problems of foam, such as poor stability and low overrun. This is because nanocellulose has a very high specific surface area, which can provide a large number of adsorption sites and promote the effective adsorption of surfactant molecules, thereby reducing the surface tension of a liquid and helping the formation and stability of the foam. In addition, when nanocelluloses are dispersed in a liquid medium, they can intertwine with each other to form a three-dimensional network structure. This structure provides an additional mechanical strength for the foam and prevents the foam from bursting easily when subjected to external forces. The hydroxyl groups on the surface of nanocellulose enable a good affinity with water molecules, which can enhance the strength of a liquid film in the foam, reduce the discharge rate of the liquid, and thus prolong the life of the foam. The multilayer foam system of the present invention is more stable than foams of monolayer film, because the multilayer foam can generally withstand a higher threshold of air pressure fluctuation. And even if one layer of the film bursts, the other layers can become stable without changing the foam structure, thereby forming an ultrastable system.

Compared with the prior art, the present invention has the following advantages and beneficial effects:

(1) The ultrastable foam mulch film of the present invention can effectively slow down the drainage, coalescence and disproportionation processes by adding nanocellulose (NCF), tetradecanol (TDA) and polyvinyl alcohol (PVA), so that the foam has a super-long life and can be stable for more than 20 days.

(2) Nanocellulose is abundant in sources and is completely biodegradable. When added in a small amount, it can improve foam stability and overrun while reducing the amount of chemical emulsifiers used, which is beneficial to ecological environment protection.

(3) The water-based foam of the present invention has good environmental adaptability and renewability. Gas, such as CO₂ gas fertilizer, may further be added to the foam film in the later stage. Additionally, it can float in paddy fields. The multilayer foam system of the present invention is more stable than foams of a monolayer film, is used as foam mulch film, and can adjust the component proportions depending on the plant growth cycle to regulate the degradation cycle of the foam mulch film, and has better effects in water retention, humidification and heat insulation.

### DESCRIPTION OF DRAWINGS

FIG. 1 shows macroscopic photographs of the foams prepared in Examples 1-3 after standing for 2 hours.

FIG. 2 shows macroscopic photographs of the foams prepared in Examples 4-6 after standing for 2 hours.

FIG. 3 shows a macroscopic photograph of the foam prepared in Comparative Example 1 after standing for 2 hours.

FIGS. 4a-4d show macroscopic photographs of the foam prepared in Example 4 after standing for 0 h (a), 24 h (b), 158 h (c), and 501 h (d).

FIGS. 5a-5e show macroscopic photographs of the foam prepared in Example 5 after standing for 0 h (a), 141 h (b), 309 h (c), 497 h (d), and 640 h (e); wherein, photographs in the left are photos of the overall state, and photographs in the right are enlarged photos of the surface layer.

FIG. 6 shows macroscopic photographs of the foam prepared in Comparative Example 1 after standing for 0 hours (left) and one week (right).

### DETAILED DESCRIPTION

The present invention is further described in detail below in combination with examples and drawings, but the embodiments of the present invention are not be limited thereto.

The examples and comparative example of the present invention for which no specific conditions are specified were carried out according to conventional conditions or conditions recommended by the manufacturers.

The raw materials and reagents used, where the manufacturers are not specified, are commercially available conventional products. The nanocellulose hydrogel in the examples was purchased from Henan Kegao Radiation Chemical Technology Co., Ltd., specifically, nanocellulose-based hydrogel (a concentration of 2 wt %). Tetradecanol (TDA, purity>99%), sodium dodecyl sulfate (SDS, purity>99%), and polyvinyl alcohol (PVA-1799, degree of polymerization 1700, degree of alcoholysis: 99.8-100%) were all purchased from Aladdin.

### Example 1

(1) 0.5 parts of SDS and 2.0 parts of TDA were weighed and added in deionized water and heated at 60° C. for 20 min to ensure that all solutes have been uniformly dispersed; after cooling, the solution was rapidly stirred at 1200 rpm at 25° C. for 5 min by mechanical stirring to generate a foam, thereby obtaining an SDS/TDA foam system.

(2) 0.5 parts of PVA were added to the SDS/TDA foam system. After the PVA was completely dissolved, the solution was rapidly stirred at 1200 rpm at 25° C. for 5 min by mechanical stirring to generate a foam.

(3) 0.5 parts of nanocellulose hydrogel were accurately weighed and added to the above mixed solution. The solution was rapidly stirred at 1500 rpm at 25° C. for 10 min by mechanical stirring to obtain a nanocellulose containing ultrastable water-based foam.

It was experimentally determined that the overrun of the water-based foam prepared in Example 1 was ˜84%.

### Example 2

(1) 2.5 parts of SDS and 2.0 parts of TDA were weighed and added in deionized water and heated at 60° C. for 20 min to ensure that all solutes have been uniformly dispersed; after cooling, the solution was rapidly stirred at 1200 rpm at 25° C. for 5 min by mechanical stirring to generate a foam, thereby obtaining an SDS/TDA foam system.

(2) 0.5 parts of PVA were added to the SDS/TDA foam system. After the PVA was completely dissolved, the solution was rapidly stirred at 1200 rpm at 25° C. for 5 min by mechanical stirring to generate a foam.

(3) 0.5 parts of nanocellulose hydrogel were accurately weighed and added to the above mixed solution. The solution was rapidly stirred at 1500 rpm at 25° C. for 10 min by mechanical stirring to obtain a nanocellulose containing ultrastable water-based foam.

It was experimentally determined that the overrun of the water-based foam prepared in Example 2 was ˜89%.

### Example 3

(1) 5.0 parts of SDS and 2.0 parts of TDA were weighed and added in deionized water and heated at 60° C. for 20 min to ensure that all solutes have been uniformly dispersed; after cooling, the solution was rapidly stirred at 1200 rpm at 25° C. for 5 min by mechanical stirring to generate a foam, thereby obtaining an SDS/TDA foam system.

(2) 0.5 parts of PVA were added to the SDS/TDA foam system. After the PVA was completely dissolved, the solution was rapidly stirred at 1200 rpm at 25° C. for 5 min by mechanical stirring to generate a foam.

(3) 0.5 parts of nanocellulose hydrogel were accurately weighed and added to the above mixed solution. The solution was rapidly stirred at 1500 rpm at 25° C. for 10 min by mechanical stirring to obtain a nanocellulose containing ultrastable water-based foam.

It was experimentally determined that the overrun of the water-based foam prepared in Example 3 was 92%.

### Example 4

(1) 2.5 parts of SDS and 2.0 parts of TDA were weighed and added in deionized water and heated at 60° C. for 20 min to ensure that all solutes have been uniformly dispersed; after cooling, the solution was rapidly stirred at 1200 rpm at 25° C. for 5 min by mechanical stirring to generate a foam, thereby obtaining an SDS/TDA foam system.

(2) 0.5 parts of PVA were added to the SDS/TDA foam system. After the PVA was completely dissolved, the solution was rapidly stirred at 1200 rpm at 25° C. for 5 min by mechanical stirring to generate a foam.

(3) 1.0 parts of nanocellulose hydrogel were accurately weighed and added to the above mixed solution. The solution was rapidly stirred at 1500 rpm at 25° C. for 10 min by mechanical stirring to obtain a nanocellulose containing ultrastable water-based foam.

It was experimentally determined that the overrun of the water-based foam prepared in Example 4 was ˜90%.

### Example 5

(1) 2.5 parts of SDS and 2.0 parts of TDA were weighed and added in deionized water and heated at 60° C. for 20 min to ensure that all solutes have been uniformly dispersed; after cooling, the solution was rapidly stirred at 1200 rpm at 25° C. for 5 min by mechanical stirring to generate a foam, thereby obtaining an SDS/TDA foam system.

(2) 0.5 parts of PVA were added to the SDS/TDA foam system. After the PVA was completely dissolved, the solution was rapidly stirred at 1200 rpm at 25° C. for 5 min by mechanical stirring to generate a foam.

(3) 1.5 parts of nanocellulose hydrogel were accurately weighed and added to the above mixed solution. The solution was rapidly stirred at 1500 rpm at 25° C. for 10 min by mechanical stirring to obtain a nanocellulose containing ultrastable water-based foam.

It was experimentally determined that the overrun of the water-based foam prepared in Example 5 was ˜95%.

### Example 6

(1) 2.5 parts of SDS and 2.0 parts of TDA were weighed and added in deionized water and heated at 60° C. for 20 min to ensure that all solutes have been uniformly dispersed; after cooling, the solution was rapidly stirred at 1200 rpm at 25° C. for 5 min by mechanical stirring to generate a foam, thereby obtaining an SDS/TDA foam system.

(2) 2.0 parts of PVA were added to the SDS/TDA foam system. After the PVA was completely dissolved, the solution was rapidly stirred at 1200 rpm at 25° C. for 5 min by mechanical stirring to generate a foam.

(3) 1.5 parts of nanocellulose hydrogel were accurately weighed and added to the above mixed solution. The solution was rapidly stirred at 1500 rpm at 25° C. for 10 min by mechanical stirring to obtain a nanocellulose containing ultrastable water-based foam.

It was experimentally determined that the overrun of the water-based foam prepared in Example 6 was ˜88%.

### Comparative Example 1

(1) 2.5 parts of SDS and 2.0 parts of TDA were weighed and added in deionized water and heated at 60° C. for 20 min to ensure that all solutes have been uniformly dispersed; after cooling, the solution was rapidly stirred at 1200 rpm at 25° C. for 5 min by mechanical stirring to generate a foam, thereby obtaining an SDS/TDA foam system.

(2) 0.5 parts of PVA were added to the SDS/TDA foam system. After the PVA was completely dissolved, the solution was rapidly stirred at 1200 rpm at 25° C. for 5 min by mechanical stirring to generate a foam, thereby preparing a water-based foam free of nanocellulose.

It was experimentally determined that the overrun of the water-based foam prepared in Comparative Example 1 was 65%.

The water-based foams prepared in Examples 1-6 and Comparative Example 1 were assayed and determined by the following methods: (1) Determination of foam overrun: An overrun is calculated by the following equation:

$$overrun = ( {V}_{f} - {V}_{s} ) / {V}_{s}$$

wherein, V_{f} and Vₛ represent a volume of a foam after stirring and an initial volume, respectively.

Short-term drainage rate: A short-term drainage rate refers to the percentage of a liquid volume discharged from a foam within 2 hours standing after foaming to the initial volume after foaming.

Short-term drainage rate ε=V/V₁*100, wherein V is a drainage volume and V₁ is a foam volume.

The stability of a foam is determined by its short-term drainage rate. A drainage rate of less than 8% (by volume) indicates “extremely good” stability, a drainage rate of 8%-10% (by volume) indicates “very good” stability, a drainage rate of 10%-12% (by volume) indicates “good” stability, and a drainage rate greater than 15% (by volume) indicates “poor” stability.

TABLE 1

| | Overrun | | |
|---|---|---|---|
| Item | (%) | Foam state | Stability |
| Example 1 | ^{~}84 | Thin and uniform foam | Good |
| Example 2 | ^{~}89 | Relatively dense and non-uniform | Good |
| | | foam | |
| Example 3 | ^{~}92 | Dense and relatively uniform foam | Very good |
| Example 4 | ^{~}90 | Dense and uniform foam | Extremely |
| | | | good |
| Example 5 | ^{~}95 | Dense and uniform foam | Very good |
| Example 6 | ^{~}88 | Dense and relatively uniform foam | Very good |
| Comparative | ^{~}65 | Thin and non-uniform foam | Poor |
| Example 1 | | | |

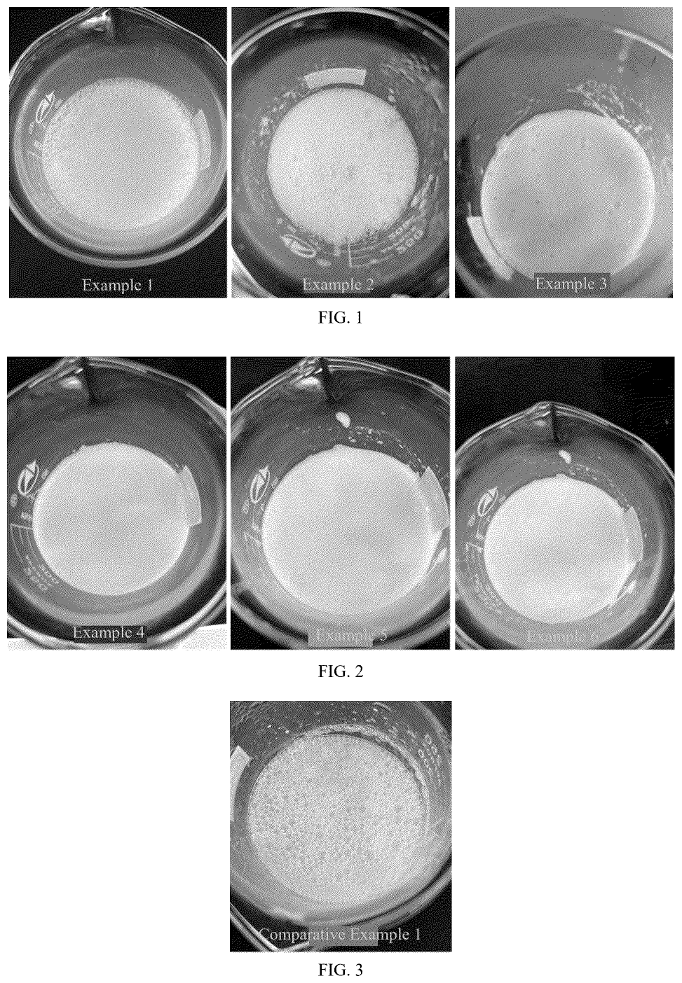

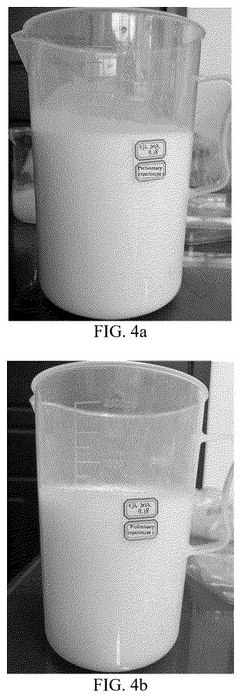

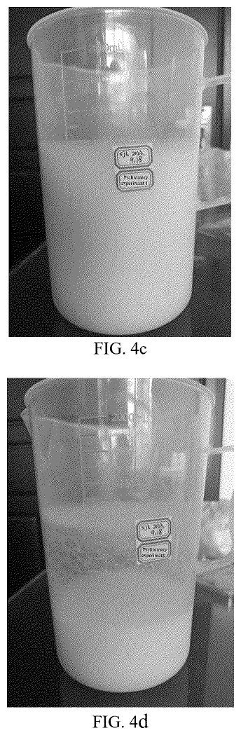

According to the data in Table 1, Examples 3-5 (combined with FIGS. 1 and 2) indicate that as the amount of NCF added increased, the overrun of the foams continuously increased. This is because nanocellulose has a high specific surface area, which can provide a large number of adsorption sites, promote the effective adsorption of surfactant molecules, reduce the surface tension of a liquid and help the formation and stability of the foam. According to the results of Examples 4-5 (FIG. 2) and Comparative Example 1 (FIG. 3), the addition of nanocellulose helps improve the stability and density of a foam. This is because nanocellulose can reduce the surface tension of a liquid, promote the formation and stability of bubbles, and its adsorption effect on the gas-liquid interface helps stabilize bubbles and prevent them from merging or bursting too quickly. In addition, the surface of nanocellulose contains numerous hydroxyl groups, which are prone to combine with water and increase the viscosity of the foam to densify the formed foam. According to the results of Examples 3 and 4 (FIGS. 1 and 2), the addition of nanocellulose can reduce the amount of the emulsifier SDS used without affecting the stability of foams.

In order to test the long-term stability of foams, experiments were conducted using Examples 4 and 5, as well as Comparative Example 1. The experimental results are as follows.

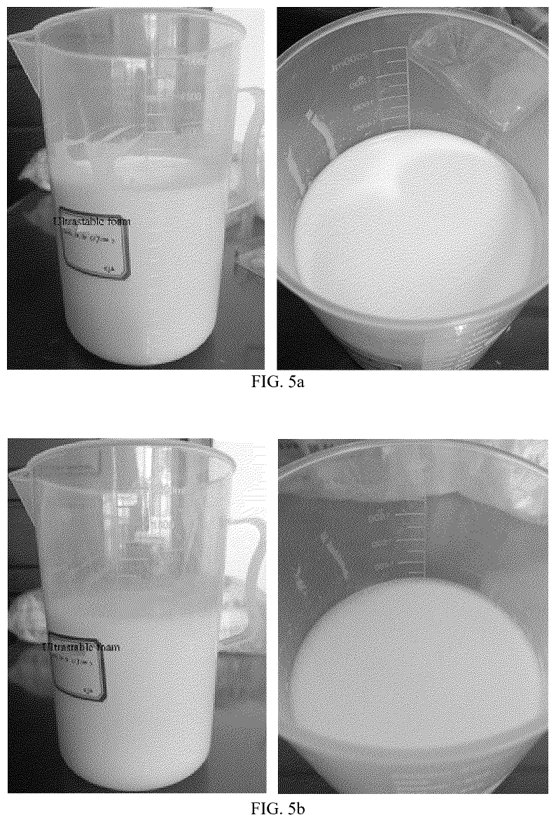

Macroscopic photographs of foams were taken using a Sony camera TX-10 after standing for 0 hours (a), 24 hours (b), 158 hours (c), and 501 hours (d). Referring to FIGS. 4a-4d (Example 4) for details, the foam just prepared was about 1400 ml of foam, which was tiny, uniformly distributed in the form of a milkshake (a). One day later, a layer of foam with a large pore size was observed on the surface, having a thickness of about 0.1 cm, from which no water discharged (b). After 158 hours, the foam was still stable, of which 100 ml of thin foam was on the upper layer and the rest of the foam was dense (c). After 501 hours, 600 ml of thin foam was retained (d). As can be seen, the foam prepared by the present invention can be stable for more than 20 days.

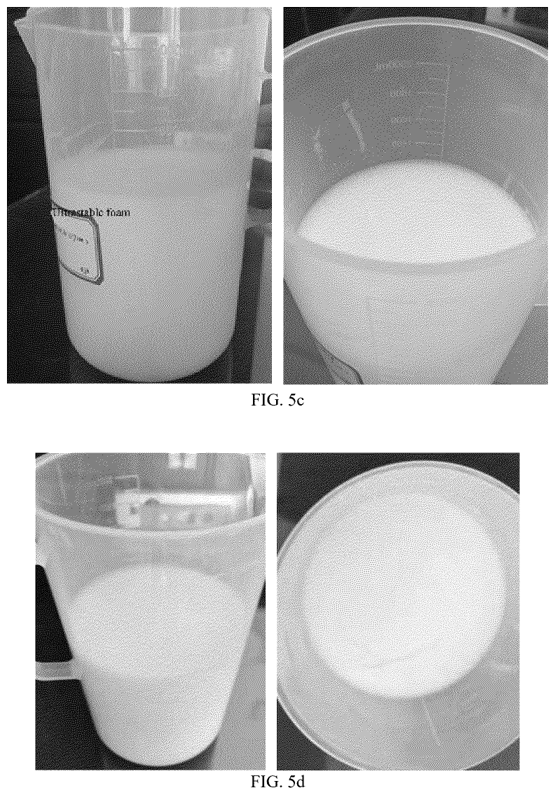

It can be seen from FIGS. 5a-5e (Example 5) that after 0 hours of storage, the foam was dense in the form of yogurt and the volume was 1250 ml (a). After 141 hours, about six days of storage, there was a slightly dry foam film on the upper layer, and the volume was 1250 ml (b). After 309 hours, about 13 days of storage, the upper film was slightly concave with a modest thickness increase, and the volume was 1250 ml (c). After 497 h, about 20 days, the foam was relatively stable as a whole, and the upper film was broken (d). After 640 h, about 26 days, only 600 ml of dense foam was left, the film was separated from the foam, and there was about 80 ml of thin foam on the upper layer (e). The upper film was very solid, which probably caused by air drying.

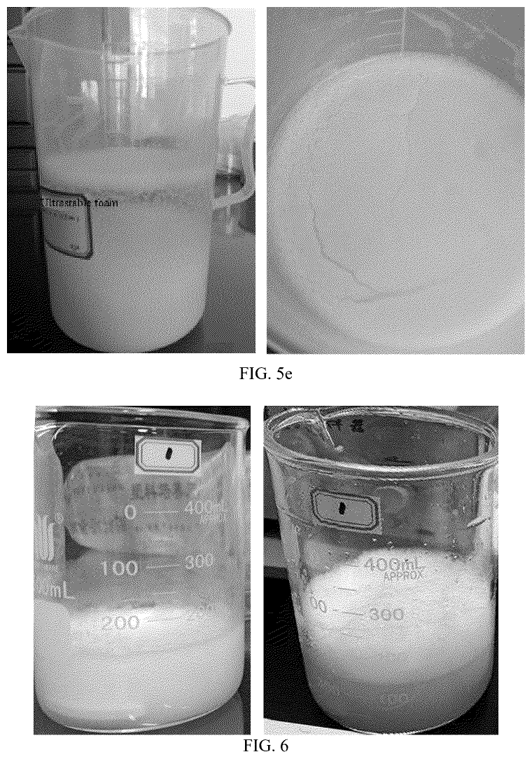

It can be seen from FIG. 6 (Comparative Example 1) that the foam had poor stability. After standing for one week, the water content discharged was relatively high, there was a film on the surface, with tiny and relatively dispersed foam.

In summary, in the SDS/DDA/PVA/NCF system, as the addition of NCF/PVA enhances the hydrogen bonds between water and solvent molecules, the distribution intensity of bound water near the sulfur atom and sodium ion of the sulfonic acid group of SDS increases significantly. In addition, the addition of NCF can enhance the gas-liquid interface and improve the density of molecules in the network. This gives rise to a decrease in the gas diffusion rate, so that the foam system is stabilized. Moreover, compared with the monolayer foam structure formed by the SDS-emulsified foam, the multilayer structure is advantageous for the balance of air pressure between the air layers in the system and has a higher fluctuation threshold than the monolayer structure, which favors the formation of an ultrastable foam.

The above examples are preferred embodiments of the present invention, but the embodiments of the present invention are not limited to the above examples. Any other alterations, modifications, substitutions, combinations, and simplifications that do not depart from the spirit and principles of the present invention shall be equivalent replacements and all fall within the protection scope of the present invention.

What is claimed is:

1. A nanocellulose containing ultrastable water-based foam, characterized in that, by mass fraction, it comprises the following components: based on 100 parts of the total mass of a compound water-based foam, 0.1-2.0 parts of nanocellulose hydrogel, 0.5-5.0 parts of sodium dodecyl sulfate, 1.0-5.0 parts of tetradecanol, 0.1-3.0 parts of polyvinyl alcohol, and the balance water; the above components are stirred at a high speed to generate a foam, thereby obtaining the nanocellulose containing ultrastable water-based foam.

2. The ultrastable water-based foam according to claim 1, characterized in that the nanocellulose comprised in the nanocellulose hydrogel has a length of 500-1000 nm and a diameter of 3-5 nm.

3. The ultrastable water-based foam according to claim 1, characterized in that the polyvinyl alcohol has an alcoholysis degree of 88%-100%.

4. The ultrastable water-based foam according to claim 1, characterized in that the mass ratio of sodium dodecyl sulfate:tetradecanol:polyvinyl alcohol:nanocellulose hydrogel is (2.5-5.0):2.0:(0.5-2.0):(0.5-1.5).

5. A method of preparing the ultrastable water-based foam according to claim 1, characterized in that it comprises the following steps:
(1) mixing sodium dodecyl sulfate and tetradecanol in water, heating the mixture to disperse all the solutes uniformly, and cooling the mixture before high-speed stirring to afford an SDS/TDA foam system;
(2) adding polyvinyl alcohol to the above foam system, and stirring at a high speed after complete dissolution; and
(3) adding nanocellulose hydrogel to the foam system of step (2), mixing uniformly, and then stirring at a high speed to afford a nanocellulose containing ultrastable water-based foam.

6. The method according to claim 5, characterized in that the high-speed stirring conditions in steps (1) to (3) are all mechanical stirring at a speed of 1000-1500 rpm for 5-10 min.

7. The method according to claim 5, characterized in that the heating condition in step (1) is heating at 60±10° C. for 20±10 min.

8. Use of the nanocellulose containing ultrastable water-based foam according to claim 1 in a foam mulch film.

9. The use according to claim 8, characterized in that the ultrastable water-based foam is sprayed onto a soil or water surface through high-pressure spray to form the foam mulch film.
